(19) United States
(12) Patent Application Publication
(10) Pub. No.: US 2016/0037980 A1
(43) Pub. Date: Feb. 11, 2016

(54) Combination Potty and Child Car Seat

(71) Applicants: Edward W. Carroll, South Plainfield, NJ (US); Shu M. Lee, Basking Ridge, NJ (US)

(72) Inventors: Edward W. Carroll, South Plainfield, NJ (US); Shu M. Lee, Basking Ridge, NJ (US)

(21) Appl. No.: 14/451,742

(22) Filed: Aug. 5, 2014

(51) Int. Cl. A47K 11/04; B60N 2/28

(52) U.S. Cl. CPC A47K 11/04; B60N 2/2821

(57) ABSTRACT

The present invention relates to an automobile child safety seat that includes a potty feature allowing the containment of a child's urine and excrement discharge in a container under the seating cushion and in which the potty feature, after being unfixed, can slide out forward for access to the collected discharge. Further, the present invention is directed to an automobile child safety seat that easily converts to a potty by the convenient removal of the seating cushion to gain access to an opening to discharge a child's urine and excrement into the container.

### FIELD OF INVENTION

The present invention is directed to child safety seats for automobiles, and is particularly directed to child safety seats for automobiles that include a potty feature. More particularly, the present invention is directed to an automobile child safety seat that includes a potty feature allowing the containment of a child's urine and excrement discharge in a container under the seating cushion and in which the potty feature, after being unfixed, can slide out forward for access to the collected discharge. Further, the present invention is directed to an automobile child safety seat that easily converts to a potty by the convenient removal of the seating cushion to gain access to an opening to discharge a child's urine and excrement into the container.

### BACKGROUND OF THE INVENTION

U.S. Pat. No. 2,994,557 describes a child's convertible chair. U.S. Pat. No. 3,127,215 describes an infant seat and bed. U.S. Pat. No. 4,199,826 describes a portable toilet. U.S. Pat. No. 4,798,412 describes a booster seat. U.S. Pat. No. 4,854,638 describes an adjustable child seat. U.S. Pat. No. 5,685,029 describes a toilet. U.S. Pat. No. 5,775,771 describes a car seat. U.S. Pat. No. 5,778,460 describes an auxiliary toilet seat. U.S. Pat. No. 5,978,976 describes a potty. U.S. Pat. No. 6,227,931 describes an electronic play set.

U.S. Pat. No. 6,240,576 describes a portable toilet. U.S. Pat. No. 6,341,386 describes a portable potty. U.S. Pat. No. 6,634,712 describes a child stool. U.S. Pat. No. 7,321,315 describes a disposable absorbent. U.S. Pat. No. 7,313,833 describes a vehicle emergency toilet system. U.S. Pat. No. 7,537,284 describes a car seat cover. U.S. Pat. No. 7,665,157 describes a toilet training chair.

U.S. Pat. No. 7,712,159 describes a convertible potty chair. Chinese Patent Publication CN2259814Y describes multi-function sets of furniture for children's daily use including a sliding bedpan. Chinese Patent Publication CN201418585Y describes multi-function children seat with a fecal discharge container that slides out from under the seat.

US Pat. No. D351,224 describes a toilet trainer. US Pat. No. D621,486 describes an animal character potty chair. US Patent No. D637,272 describes combination portable toilet and baby changing table. US Pat. No. D639,403 describes a potty.

US Pat. No. D652,640 describes a combination car potty seat.

When travelling with a young child in an automotive vehicle such as a car, sport utility vehicle, or minivan, the child must be safely confined in a child car seat. Children below approximately 20 lb in weight are generally advised to be in car seats that face backwards, towards the rear of the vehicle. Children above approximately 20 lbs are generally in car seats that face forward. The present invention is directed to car seats that face forward.

Vehicular trips are interrupted when children need to use the toilet. The vehicle needs to stop at an appropriate location to use a public permanent toilet or to set up and use a portable toilet. There are many situations when such interruptions are undesirable or difficult such as in unfamiliar areas, in dangerous areas, or in very heavy traffic areas. Thus, there is a need for a convenient in-vehicle toilet.

Young children are often not able to give adequate warning of their need to use a toilet with sufficient time to find a public toilet facility. Especially in an unfamiliar area, the adult may not know, or be able to find, a convenient public toilet nearby. Further, the child might not have the ability to hold in the toilet need long enough to wait for the public toilet. A consequence is that the vehicle seat be become soiled. Thus, there is a need for a potty in the vehicle conveying a child. A convenient place for a potty is the child seat itself because children generally must be confined in such child seats when being driven in a vehicle. Accordingly, there is a need for a child seat that converts easily into a potty.

Young children might not yet be toilet trained. Such children generally wear disposable or washable diapers. Young children above approximately 20 lbs weight generally reach a stage in their development and growth in which they are in the process of being toilet trained. During such training, it would be useful to have a toilet available in a vehicle to provide easy access to a potty, thereby minimizing disadvantageous anxiety on the part of the child being trained and the adult providing training Further, as the child nears being fully trained, a convenient potty in the vehicle minimizes the number of diapers that need to be brought along on a trip—thus lessening the cost and space associated with diapers.

There continues to be a need for a child car seat, for children above approximately 20 lbs in weight that conveniently converts to a potty, while conforming to all regulations and guidelines for construction, safety and use of such car seats.

Accordingly, the present invention is directed to a child car seat conforming to all regulations and guidelines for such car seats for children weighing more than approximately 20 lbs that conveniently converts to a potty.

### SUMMARY OF THE INVENTION

The present invention concerns a child's car seat that conveniently converts to a potty. In one aspect the car seat/potty of the present invention includes a latchable discharge receiving container that advantageously slides forward away from the seatback of the vehicle in which the car seat/potty is installed. The discharge receiving container sliding forward is advantageous compared to containers that are fixed because of added convenience in disposal of waste, in cleaning the container, and ease of replacement of old soiled containers. The discharge receiving container sliding forward is advantageous over containers that slide to the side in that the forward direction minimizes encroachment into the passenger space of others that might be seated next to the car seat/potty.

It is advantageous for the receiving container to be latchable to avoid the container sliding out upon strong deceleration of the vehicle. The latch can be any convenient mechanism such as, for example, a pin and hole, a hook and eye, mating indent and protrusion, or a cam wheel against a firm surface. Other latches are known in the art of sliding containers and may be used. More than one latch may be included for added safety.

Further, it is advantageous for the receiving container to be shaped with sloping sides to minimize splashing of its contents if the container is not emptied immediately upon its toilet use. The sides conveniently can be tapered from the base shape upwards to end as an opening corresponding to the potty opening. Advantageously, the sides of the container should meet the floor of the container not by a sharp corner but by a rounded transition from the sloped vertical side to the horizontal container floor. Such a rounded transition allows for convenient cleaning of the container without sharp creases that can hide dirt or discharge. Additionally, sharp corners are more difficult to clean thoroughly than are smooth rounded surfaces to clean.

The slope sided receiving container can have a decorative front that is attached to the container. The decorative front serves to maintain a unified look of the car seat.

The present invention also relates to a child's car seat that conveniently converts to a potty by removing a cover that slides forward, away from the seatback of the seat on which the seat/potty is installed. In one embodiment, the sliding cover is over the potty seat, which has the opening that accesses the waste discharge container. In another embodiment, the sliding cover is under the potty seat. In each embodiment, the sliding cover in the closed position converts the potty into a child car seat and in the open position converts the child car seat into a potty.

It is advantageous for the cover to be a sliding mechanism because the child can be left strapped in the seat while the cover is removed. The child then only needs a small lift to remove the child's lower clothing to perform the child's toilet needs. The ability to keep the child strapped-in is a major advantage over other converting covers such as hinged ones, which require the child to be unstrapped, removed from the seat, and replaced on the seat once the cover has been lifted. Such use demands that a safe place to stop the vehicle be found. On a busy interstate highway, such demands can lead to the vehicle being unsafely stopped on a shoulder of the road.

The sliding cover may be padded for comfort. If the cover is under the potty seat, the cover may be contoured to fill the access hole for comfort and appearance. The sliding mechanism is designed to allow for the cover to securely move into and out of position. One or more latching mechanisms should be included to safely avoid the cover moving under strong deceleration. The latch can be any convenient mechanism such as, for example, a pin and hole, a hook and eye, mating indent and protrusion, or a cam wheel against a firm surface. Other latches are known in the art of sliding panels and may be used. More than one latch may be included for added safety.

### BRIEF DESCRIPTION OF THE FIGURES

FIG. 1: Depicts a front perspective view of one embodiment of the present invention.

FIG. 2: Depicts a cross-sectional view of an embodiment of the present invention in the car seat configuration.

FIG. 3: Depicts a cross-sectional view of an embodiment of the present invention in the potty seat configuration.

FIG. 4: Depicts a cross-sectional view of an embodiment of the present invention in which the waste container is in an intermediary position to removal.

FIG. 5: Depicts a cross-sectional view of an embodiment of the present invention in which the waste container is in position to be removed.

FIG. 6: Depicts a cross-sectional view of an embodiment of the present invention in the car seat configuration.

FIG. 7: Depicts a cross-sectional view of an embodiment of the present invention in which the sliding cover is at an intermediary position of converting the present invention between a car seat and a potty seat configuration.

FIG. 8: Depicts a perspective view of an embodiment of the present invention.

FIG. 9: Depicts a perspective view of an embodiment of the present invention.

### DETAILED DESCRIPTION OF THE INVENTION

It is understood that the invention is not limited to the presented details of the construction, materials, and embodiments as illustrates in the accompanying drawings. The invention concepts are capable of other embodiments and of being practiced and realized in different ways by applying the presented description herein.

It is essential that the combination potty and child's car seat of the present invention comport with and meet all laws, regulations, and guidelines pertaining to performance standards, including those at the Federal, state, and local levels and those suggested by the National Highway Traffic Safety Administration (NHTSA). Accordingly, the combination potty and child's seat of the present invention includes such slots, channels, and attachment points as needed to effectively and safely confine and restrain a child against the dangers associated with children not so confined and restrained in an accident.

The combination potty and child's car seat of the present invention is for children in the “Group 1” category, which utilizes an adult seat belt to hold it in place and a five-point harness to hold the child in the seat. The weight of the child should be from about 20 to 40 lbs.

A combination potty and child's car seat comprises a frame having a seat back surface, a waste collection space, and a support member having a seat sitting surface wherein the support member has a toilet access opening in the seat sitting surface that provides access to the waste collection space of a person's waste discharge through the toilet access opening for the person sitting supported by the support member; a conversion member that in a first position closes off the toilet access opening to deny access, to the person sitting supported by the support member, to the toilet access opening in the seat sitting surface and in a second position allows access, to the person sitting supported by the support member, to the toilet access opening; a collection drawer that, in a first position, is substantially within the waste collection space, wherein the drawer opening is cooperative with the toilet access opening effective to catch waste discharge that is discharged through the access opening, and wherein the collection drawer slides between a third position and a fourth position wherein the collection drawer is less within the waste collection space than when in the third position; wherein the third position is effective to catch waste discharged through the toilet access opening into the waste containing volume and the fourth position is effective to allow removal of waste discharge collected by the collection drawer.

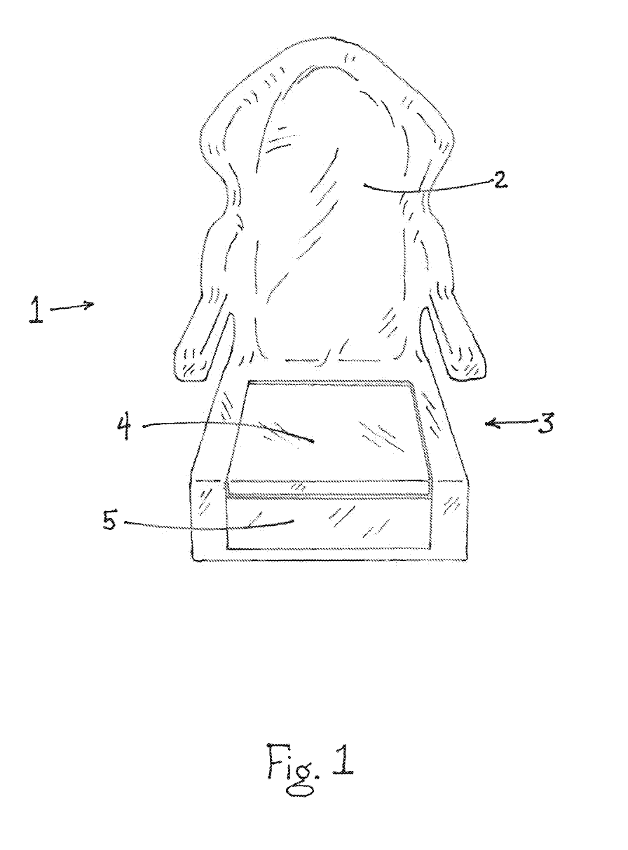

Referring to FIG. 1, a front perspective view of one embodiment of the child car/potty seat of the present invention, car/potty seat 1 has a seat back surface 2 and a seat sitting surface 3. Seat sitting surface 3 includes a conversion member 4 shown in a position that converts the child car/potty seat to a child car seat. Drawer 5 provides access to the waste containing volume.

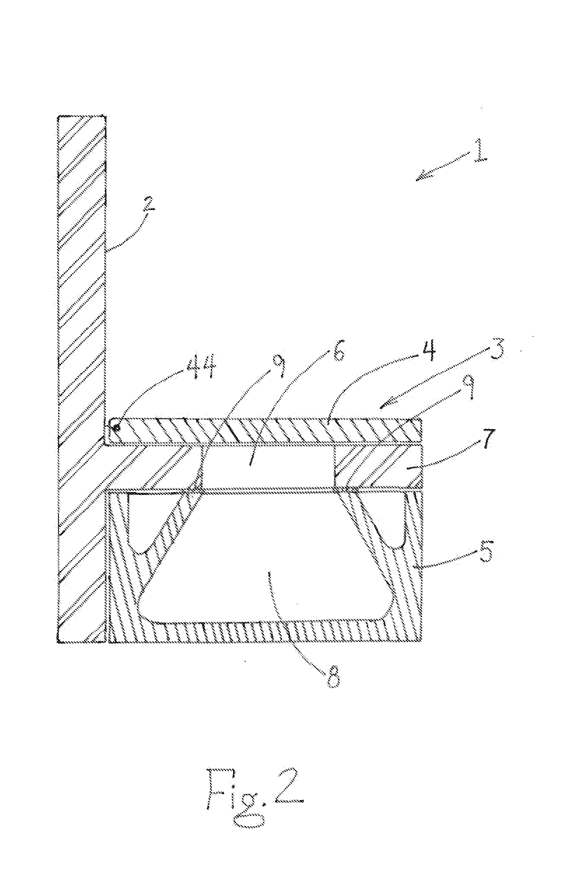

Referring to FIG. 2, a cross-sectional view of an embodiment of the present invention in the car seat configuration, car/potty seat 1 has a seat back surface 2. Conversion member 4 is shown in a first position denying access to toilet access opening 6 in seat sitting surface support member 7. In this first position, conversion member 4 forms part of seat sitting surface 3. In this embodiment, conversion member 4 pivots about hinge pin 44. Waste containing volume 8 is shown integrated into drawer 5. Drawer 5 is shown in a first position to catch waste discharged through toilet access opening 6 into waste containing volume 8. Optional gasket 9 helps cleanliness.

In another embodiment of the present invention, referring to FIG. 2, waste containing volume 8 is formed by drawer 5 itself That is, the top opening of volume 8 is approximately the same size and shape as the floor of volume 8. The dimensions of the bottom of drawer 5 are approximately a square or rectangle of approximately 7-12″×7-12″ convenient to fit within the base of the car/potty seat 1.

It is understood that all objects may be described in Cartesian space by reference to three orthogonal axis. In one embodiment of the present invention, the conversion member pivots about one of its axis.

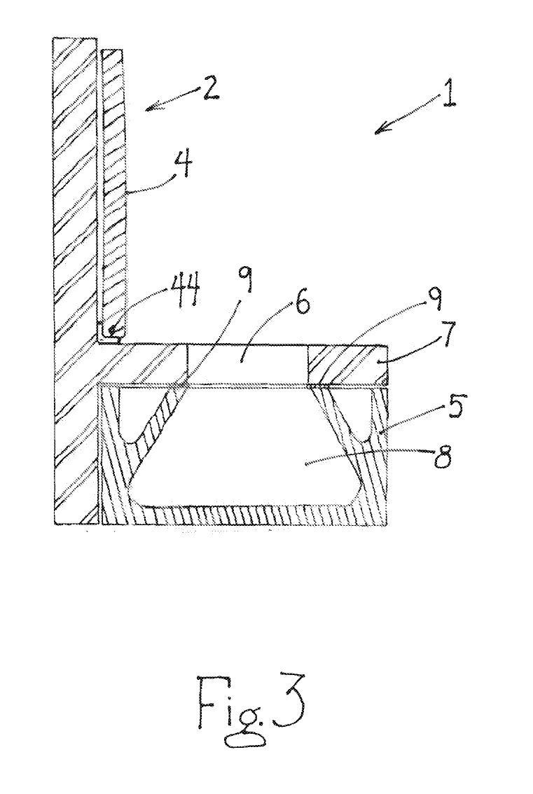

Referring to FIG. 3, a cross-sectional view of an embodiment of the present invention in the potty seat configuration, car/potty seat 1 has a seat back surface 2. Conversion member 4 is shown in a second position providing access to toilet access opening 6 in seat sitting surface support member 7. In this second position, conversion member 4 forms part of seat back surface 2. In this embodiment, conversion member 4 pivots about hinge pin 44. Waste containing volume 8 is shown integrated into drawer 5. Drawer 5 is shown in a first position to catch waste discharged through toilet access opening 6 into waste containing volume 8. Optional gasket 9 helps cleanliness.

In another embodiment of the invention, referring to FIG. 3, toilet access opening 6 is circular with a diameter of approximately 5-9″. It is advantageous for the edge of toilet access opening 6 to be at least approximately 2-4″ from the front, side, and back edges of seat sitting support member 7. That is, the child should have a seating surface of at least approximately 2-4″ around toilet access opening 6.

The toilet access opening should be conveniently sized so that the child has easy access without needing to worry about missing the waste containing volume or worry about falling awkwardly into the toilet access opening.

In another embodiment of the invention, referring to FIG. 3, toilet access opening 6 is rectangular with a dimension of approximately 5-9″×5-9″. The corners of the opening may be rounded for comfort. It is advantageous for the edge of toilet access opening 6 to be at least approximately 2-4″ from the front, side, and back edges of seat sitting support member 7. That is, the child should have a seating surface of at least approximately 2-4″ around toilet access opening 6.

In an embodiment of the present invention, referring to FIG. 3, conversion member 4 is circular or ovoid. Conversion member 4 is conveniently dimensioned to cover toilet access opening 6 and fit stably on sitting surface support member 7. Conversion member 4 should be padded for comfortable seating of the child as a car seat.

In an embodiment of the present invention, referring to FIG. 3, conversion member 4 is square or rectangular. Conversion member 4 is conveniently dimensioned to cover toilet access opening 6 and fit stably on sitting surface support member 7. Conversion member 4 should be padded for comfortable seating of the child as a car seat.

Referencing the three axis that can describe an object, one axis can be defined as a forward/backward axis in which, for an object in an automobile moving along a straight line, the object moves forward relative to the car when the car decelerates, and moves backward when the car accelerates. It is advantageous for the drawer of the present invention to slide along an axis forward/backward to allow easy access to the drawer and its contents for cleaning without need to interfere with passengers or objects next to the combination potty and car seat of the present invention.

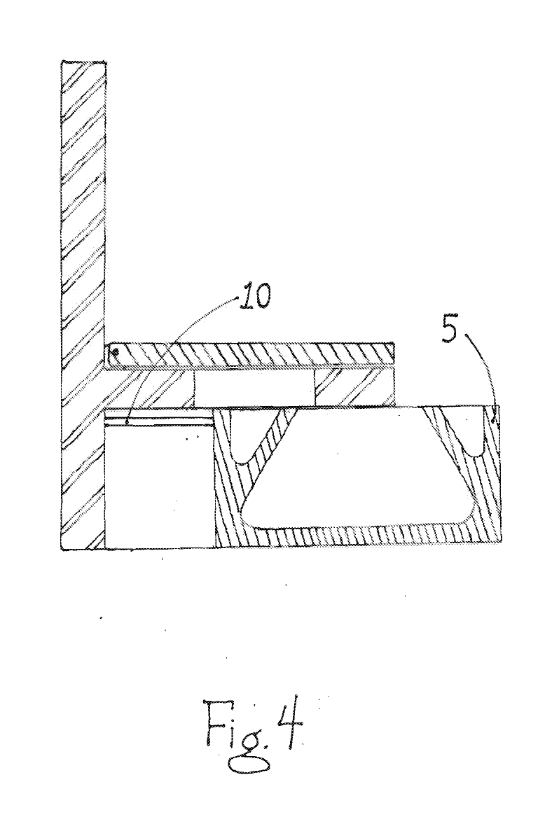

Referring to FIG. 4, a cross-sectional view is shown of an embodiment of the present invention in which drawer 5 is in an intermediary position to removal. In this embodiment, drawer 5 rides along track 10.

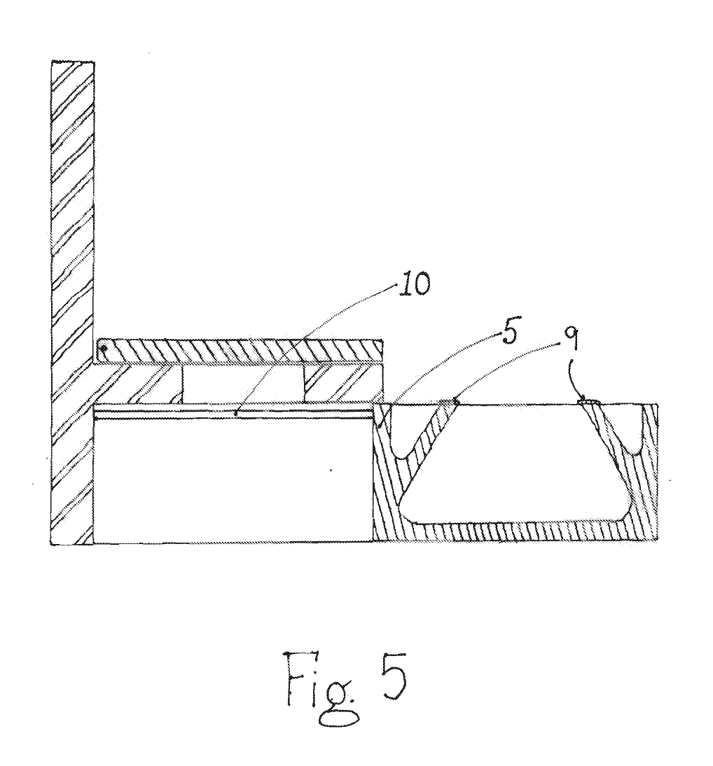

Referring to FIG. 5, a cross-sectional view of an embodiment of the present invention is shown in which the waste container is in position to be removed. In this embodiment, drawer 5 rides along track 10. In this embodiment, optional gasket 9 is shown adhered to drawer 5.

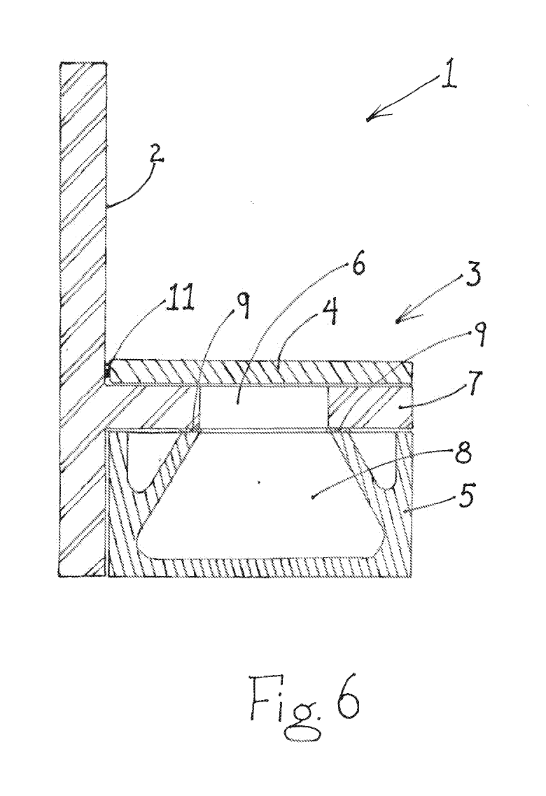

Referring to FIG. 6, a cross-sectional view of an embodiment of the present invention in the car seat configuration is shown. Car/potty seat 1 has a seat back surface 2. Conversion member 4 is shown in a first position denying access to toilet access opening 6 in seat sitting surface support member 7. In this first position, conversion member 4 forms part of seat sitting surface 3. In this embodiment, conversion member 4 slides along track 11. Waste containing volume 8 is shown integrated into drawer 5. Drawer 5 is shown in a first position to catch waste discharged through toilet access opening 6 into waste containing volume 8. Optional gasket 9 helps cleanliness.

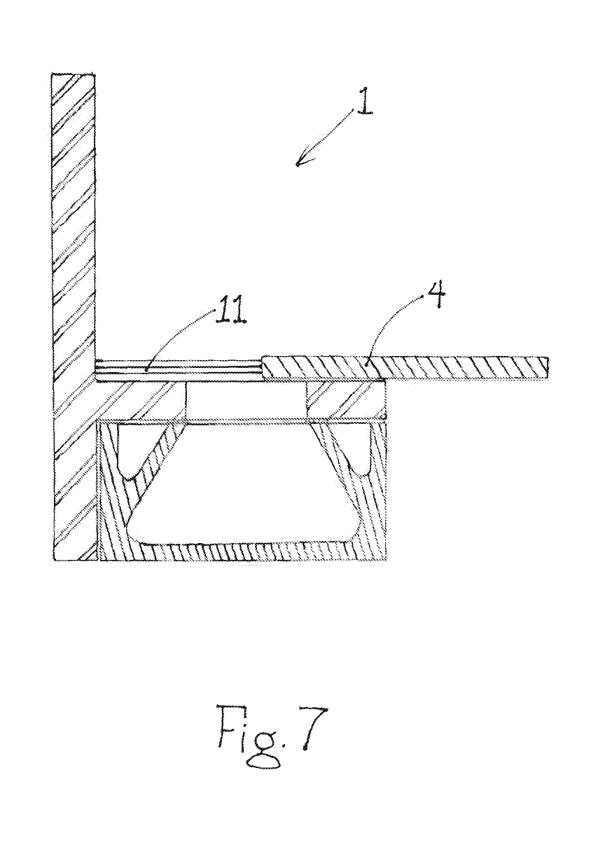

Referring to FIG. 7, a cross-sectional view of an embodiment of the present invention is shown in which conversion member 4, sliding along track 11, is at an intermediary position of converting the present invention between a car seat and a potty seat configuration. Removal of conversion member 4, by sliding it along track 11 until conversion member 4 is detached from car/potty seat 1, converts car/potty seat 1 for potty use.

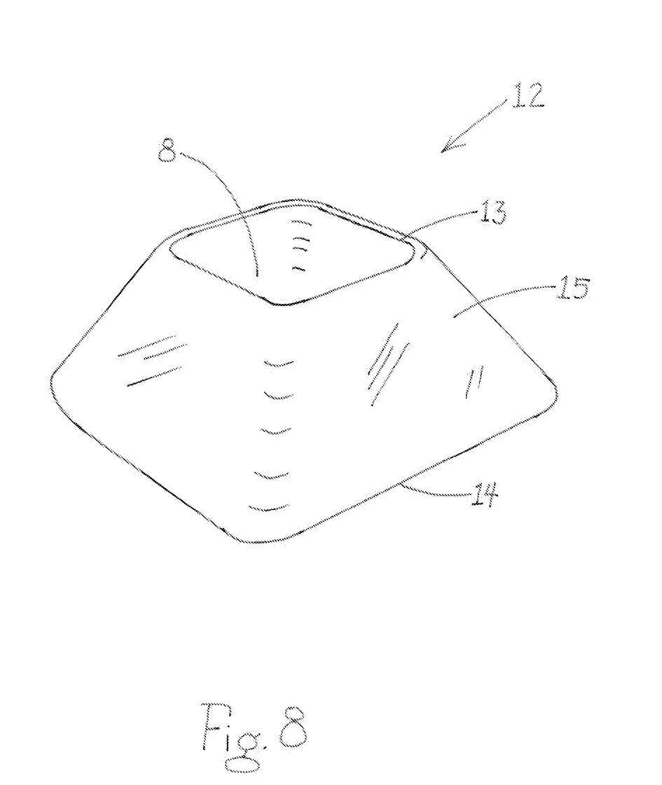

FIG. 8: Depicts a perspective view of an embodiment of the present invention. Waste container 12 encloses waste containing volume 8 except for opening 13. Opening 13 is sized to corresponding to toilet access opening 6 (not shown). Base 14 is sized convenient to fit in drawer 5 (not shown) and may be attached or integrated into drawer 5. Sides 15 taper between base 14 and opening 13. The height of waste container 12 is sized convenient to receive waste discharge through toilet access opening 6 into waste containing volume 8 with minimal deposit of waste discharge elsewhere other than waste containing volume 8 or toilet access opening 6.

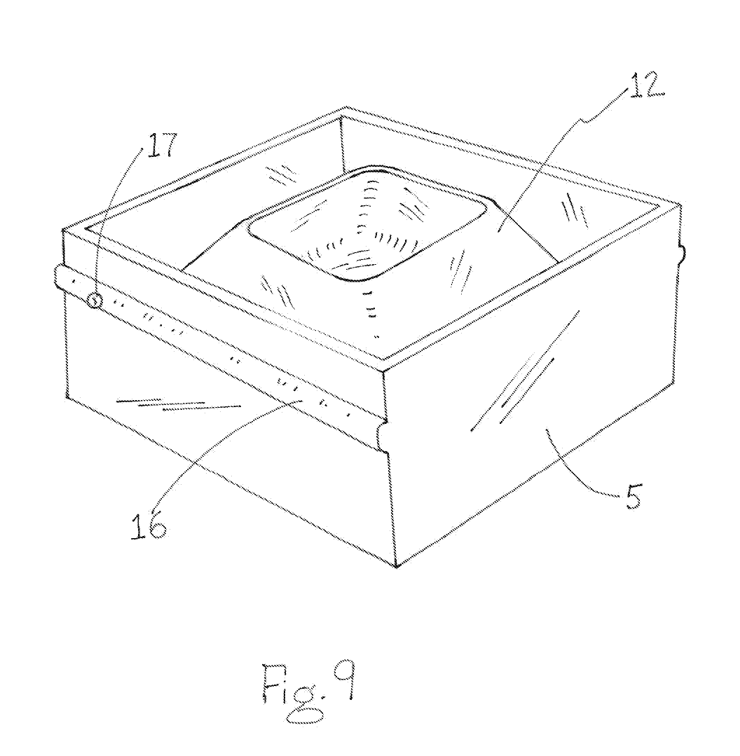

Referring to FIG. 9, a perspective view of an embodiment of the present invention is shown. Waste container 12 is shown attached to drawer 5. Sliding member 16 rides along track 10 (not shown). In this embodiment, spring-loaded button 17 cooperates with a suitable hole in car/potty seat 1 (not shown) to latch drawer 5 to car/potty seat 1 when drawer 5 is in its first position. In the first position of drawer 5, spring-loaded button 17 is urged by its spring into a suitable hole (not shown) in car/potty seat 1 to prevent sliding movement of drawer 5 from its first position. By the action of pushing spring-loaded button 17 through the suitable hole while urging drawer 5 away from its first position towards its release position from car/potty seat 1, drawer 5 is moved along track 10 to be released from car/potty seat 1.

In another embodiment of the present invention, referring to FIG. 9, waste container 12 is omitted and drawer 5 itself serves as the waste container.

The above disclosure of specific embodiments is illustrative of the broad concepts embraced by the present invention.

What is claimed is:

1. A combination potty and child's car seat comprising:
a frame comprising a seat back surface, a waste collection space, and a support member having a seat sitting surface wherein the support member has a toilet access opening in the seat sitting surface that provides access to the waste collection space of a person's waste discharge through the toilet access opening for the person sitting supported by the support member;
a conversion member that in a first position closes off the toilet access opening to deny access, to the person sitting supported by the support member, to the toilet access opening in the seat sitting surface and in a second position allows access, to the person sitting supported by the support member, to the toilet access opening;
a collection drawer that, in a first position, is substantially within the waste collection space, wherein the drawer opening is cooperative with the toilet access opening effective to catch waste discharge that is discharged through the access opening, and wherein the collection drawer slides between a third position and a fourth position wherein the collection drawer is less within the waste collection space than when in the third position; wherein the third position is effective to catch waste discharged through the toilet access opening into the waste containing volume and the fourth position is effective to allow removal of waste discharge collected by the collection drawer.

2. The combination potty and child's car seat according to claim 1, wherein the collection drawer slides between the third and fourth positions in a forward/backward axis.

3. The combination potty and child's car seat according to claim 2, wherein the conversion member pivots about an axis.

4. The combination potty and child's car seat according to claim 2 wherein the conversion member slides along an axis.

5. The combination potty and child's car seat, according to claim 4, wherein the axis is forward/backward.
